(19) United States
(12) Patent Application Publication
(10) Pub. No.: US 2020/0315098 A1
(43) Pub. Date: Oct. 8, 2020

(54) DEVICE FOR THE VACUUM STORAGE AND TRANSPORTATION OF GRAIN

(71) Applicant: Frédéric POUJAUD, Villemur-sur-tarn (FR)

(72) Inventor: Frédéric POUJAUD, Villemur-sur-tarn (FR)

(21) Appl. No.: 16/310,783

(22) PCT Filed: Jun. 17, 2017
(86) PCT No.: PCT/IB2017/053611

§ 371 Date: Dec. 17, 2018

(30) Foreign Application Priority Data
Jun. 17, 2016 (FR) 16/70323

(51) Int. Cl. A01F 25/14; B65D 81/20; B65B 1/18; B65B 25/02; B65B 31/04; B65B 43/26

(52) U.S. Cl. CPC A01F 25/14; B65D 81/2038; B65B 1/18; A01F 2025/147; B65B 31/047; B65B 31/048; B65B 43/262; B65B 25/02

(57) ABSTRACT

A device for the vacuum storage and vacuum transport of dry or wet grain under anaerobic conditions is provided, comprising: an enclosure sealed to all types of gas having at least one filling element, the filling element, when in the open position, allowing the enclosure to be filled with grains and, when in the closed position, further allowing the enclosure to be tightly sealed, and at least one non-return air valve allowing gaseous fluid transfer by the suction of air through the valve only from the inside of the enclosure to the outside of the enclosure. The device further comprises a handling arrangement associated with the enclosure and comprising a transport bag suitable for receiving the sealed enclosure and having straps that form loops that can be gripped directly by a user or by lifting equipment.

### BACKGROUND

### Technical Field

The disclosure relates in general to the vacuum storage and transportation of grain.

It relates more particularly to a device designed for and suited to the vacuum storage and vacuum transportation of dry or wet agricultural seed grain or seeds.

Embodiments of the invention find applications particularly in agriculture and in the agri-foodstuffs industry.

### Technological Background

In the remainder of this document, the terms “grain” and “seed grain” will be employed generically to refer both to agricultural seeds and to agricultural products intended for consumption, such as cereals for example, which are liable to require storage and/or transportation. Nevertheless, the possible applications of the device are not intended to be limited to these examples of contents.

Grain is usually stored in the open air, for example in grain silos, and this has the effect of accelerating the degradation of the product: bacterial growth, oxidation, growth of insects, absorption of water, enzymatic degradation, in particular. In order to limit these phenomena one solution commonly employed is to store in a cold room at low temperature in order to slow the degradation process. Another solution involves a step of drying (dehydrating) the raw material with a regular application of a liquid insecticide, or gaseous fumigation with insecticide in a hermetically sealed container. Finally, the “vacuum” storage method allows the seed grain to be placed in an inert environment, thus considerably slowing the various degradation processes.

“Vacuum storage” more specifically means storage in an environment in which the pressure is lower than atmospheric pressure. Vacuum storage devices exist for certain widely consumed products. The underlying principle is as follows: having inserted the element in a hermetic bag, the bag is sealed and any air remaining inside is sucked out. The desired objectives are not always the same, depending on the objects inserted inside: preservation of foodstuffs and fresh products, space saving (in the case of quilts and sleeping bags for example), protection of garments, etc.

Furthermore, the grain may be transported using giant bags more commonly known by their English name of “bigbags”. From a logistical standpoint, this allows goods that are to be transported to be packaged in a way that is modular and standardized on an international scale. The standard and generic bigbag used is dimensioned to fit onto a pallet with a surface area measuring 1 m×1 m. The height may vary between 1 m and 2.5 m, depending on the contents. For grain, the bigbags are made of thick plastics (generally polypropylene) (thickness in excess of 100 microns) and woven in order to give the bigbag sufficient mechanical strength. Sometimes an internal layer is added in order to provide better sealing. While packaging the grain in bigbags makes for easier transport, it does not allow for durable goods storage because the environment inside the bigbag is not closed.

### Description of the Related Art

Document EP 0132482 discloses a vacuum storage installation for agricultural raw materials, for preserving under slow dehydration products containing a certain quantity of water (such as cereals and seeds for example). The installation takes the form of a fluidtight silo inside which a certain level of vacuum is created and maintained, depending on the moisture content of the product stored. However, such an industrial installation is purely static. It is therefore suitable for storage but does not allow the contents to be transported. In conclusion, this device is therefore still technically ill suited to the vacuum storage and transportation of grain in industrial quantities.

Document EP 2149508 discloses a liquid transport container. The system has a capacity in the region of 1 m³ and comprises a metal cage placed on a pallet. Inside the metal cage there is an internal pouch made of plastic. An external envelope (a kind of tarpaulin) fixed to the metal cage is arranged between the internal pouch and the metal cage. The internal pouch is not attached to the external envelope and can be filled until it reaches the volume delimited by the metal cage. This system can be used for transporting liquid or granular elements, thus covering numerous types of different agricultural foodstuffs. Nevertheless, it does not allow seed grain to be packaged under vacuum.

Document FR 2912997 discloses an adaptable compressive storage device. The device comprises a storage bag contained inside a storage box. This storage bag is intended to accept compressible textile items (quilts, garments, etc.). It is fitted with an air nonreturn valve so that it can have its air removed. The storage box, which protects the storage bag, has a size that can adapt according to the extent to which the storage bag is filled. The device described therefore employs the vacuum storage principle but is designed for inert products with a view to affording space savings for storing textile items in a household usage context. That document contains no teaching of use to the vacuum storage and transportation of grain in industrial quantities.

Document WO 2006/012528 discloses a device for preserving products under vacuum. According to that document, this is a plastic pouch comprising at least one layer of polymer, with, at the periphery of the pouch, an opening providing access to the interior space. This opening can be reclosed using a device so as to seal the inside of the pouch. The closure device has two stages: interlocking parallel grooves and a sealant mixture. The pouch comprises a valve onto which a portable pump can be fitted in order to suck out the air from inside the pouch. This pump is provided with an air/liquid separation system. The device according to this invention uses the vacuum storage principle but is designed for food products commonly consumed on an individual or family scale: mainly for preserving leftovers and fresh products.

### BRIEF SUMMARY

Embodiments of the present invention seek to eliminate or, at the very least, lessen, all or some of the aforementioned disadvantages of the prior art, by proposing a device technically suited to the vacuum storage and transportation of seed grain in industrial quantities.

To this end, a first aspect of the invention proposes a device for the vacuum storage and vacuum transportation of wet or dry seed grain under anaerobic conditions, comprising:
a container hermetically sealed against any type of gas, having:
   at least one filling element which, when the element is in the open position, allows the container to be filled with seed grain and also, when said element is in the closed position, allows the container to be hermetically sealed, and
   at least one air nonreturn valve allowing gaseous fluidic transfer by sucking air through the valve only from the inside of the container toward the outside of the container, and
handling means or a handling arrangement associated with the container and comprising a transport bag suited to accommodating the hermetic container and which has straps forming ears to allow the bag to be grasped directly by a user or by lifting gear.

The use of the vacuum inerting principle makes it possible to avoid fermentation (apart from anaerobic, for example alcoholic, fermentation) in the case of wet seed grain such as maize intended for cattle feed for example. In the case of dry seed grain such as seeds, inerting avoids insect growth and pests, allowing the seeds and seed grain to maintain its strong germination quality.

Furthermore, in embodiments considered in isolation or in combination:
the container may be a flexible and hermetic bag made of a thermoplastic material suited to the preservation of agricultural products;
the filling element may be a mouth which is inscribed in the continuity of the envelope of the container;
the filling element may be heat sealed;
the air nonreturn valve may be integrated directly into the surface of the container;
the container may comprise sensors suited to detecting or measuring information relating to the seed grain stored in the sealed hermetic container;
the container may further comprise at least one RFID label to identify the device from among a plurality of similar devices;
the container or the associated transport means may further comprise a geotag;
in order to preserve wet or dry seed grain under anaerobic conditions and transport it without breaking the vacuum chain, the gaseous environment of the material to be preserved may be rendered fluidically closed in the hermetic container and have a lower gaseous dioxygen content than the ambient air, for example of the order of 20% of the gaseous dioxygen content of the ambient air at the time that the hermetic container is sealed.

In a second aspect, the invention also proposes a method for preserving wet or dry seed grain under anaerobic conditions and transporting it without breaking the vacuum chain, characterized in that the gaseous environment of the material to be preserved is rendered fluidically closed in the hermetic container of a device according to the first aspect hereinabove, and has a lower gaseous dioxygen content than the ambient air, for example of the order of 20% of the gaseous dioxygen content of the ambient air at the time that the hermetic container is sealed.

Finally, in a third aspect, the invention also relates to a storage container as defined hereinabove with reference to the device for the vacuum storage and transportation of seed grain according to the first aspect.

Embodiments of the invention thus afford a simple and novel technical solution to the problem of the vacuum storage and vacuum transportation of grain on an industrial scale. In particular, the device according to an embodiment of the invention affords a technical solution to this problem by enabling three functions simultaneously:
the grain is preserved under vacuum, with all the advantages and economies of scale that that affords;
this grain can be transported in a modular manner that falls within international logistics standards, all without interrupting the vacuum chain;
it is simple to use and requires very little by way of operational facilities and additional equipment.

### BRIEF DESCRIPTION OF THE SEVERAL VIEWS OF THE DRAWINGS

Further features and advantages of embodiments of the invention will become apparent from reading the following description. This description is purely illustrative and is to be read in connection with the attached drawings in which:

FIG. 1 is a view of a hermetic container of a device according to an embodiment of the invention;

FIG. 2 is a view of a molding frame that can be used for filling the container of FIG. 1;

FIG. 3 is a view of equipment for filling the container of FIG. 1 using the molding frame of FIG. 2;

FIG. 4 is a view of one embodiment of the storage and transport device according to the invention; and

FIG. 5 is a cross-sectional diagram of a valve suitable for placing a container of a device according to FIG. 1 or FIG. 4 under vacuum.

### DETAILED DESCRIPTION

Embodiments of the device for the vacuum storage and vacuum transportation of seed grain on an industrial scale are given by way of nonlimiting example in the following description. In this description and in the attached drawings, the same elements or similar elements bear the same numerical references from one figure to another.

The grain preservation method employed using the device according to an embodiment of the invention is an anaerobic preservation method. Specifically, after a container that is fluidtight against all types of gas has been filled with grain and the container has been sealed closed and evacuated, respiration by the microflora inside the container consumes any oxygen left in the container. The carbon dioxide produced then occupies the gaps between the individual seed grains and thus inhibits any enzyme activity. Tests conducted have shown that the oxygen left inside the container is used up at the latest in the 15 hours following evacuation. The method implemented according to an embodiment of the invention therefore allows the grain to be placed in an inert environment and consequently allows the various degradation processes to be slowed considerably.

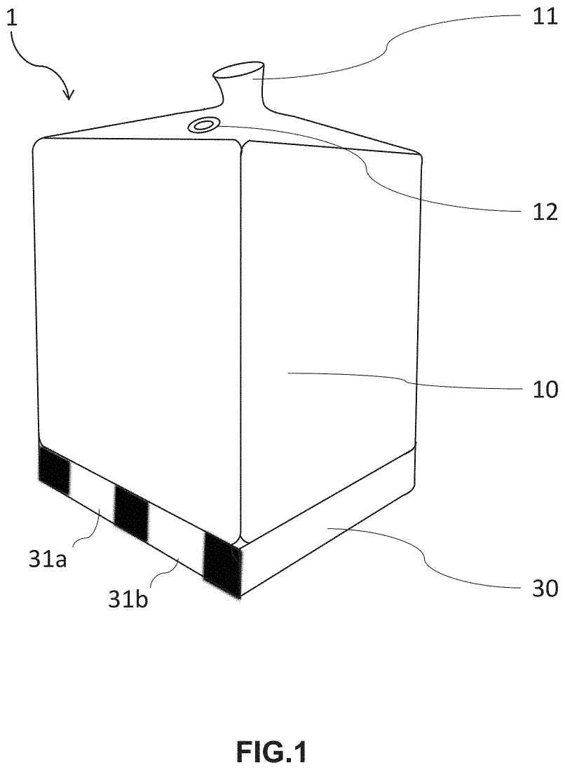

With reference to the diagram of FIG. 1, a bag 10 acting as a storage container completely fluidtight against any type of gas is depicted and delimits an interior space capable of accommodating wet or dry seed grain.

The bag 10 comprises a filling mouth 11 that can be sealed closed once the bag 10 is full of grain and before the air inside is sucked out to create the vacuum in the container. In one embodiment, the filling mouth 11 is inscribed in the continuity of the envelope of the container 10.

The bag 10 moreover comprises at least one air nonreturn valve 12, to allow the internal air to be evacuated, for example by suction, with a device for sealing the valve, which device will be described later on with reference to the diagram that is FIG. 5.

Regarding the container 10 more particularly, this is preferably a flexible thermoplastic polymer bag, completely hermetically sealed against any type of gas. According to one preferred embodiment, the shape of the bag can be likened to that of a party balloon inasmuch as its surface is uniform and made as a single piece (i.e., without joints or seams) and inasmuch as the bag has just one opening, at its top, forming the filling mouth. The shape of the bag may be cylindrical, but it is preferably cubic, for space-saving reasons if several identical or similar bags placed side by side are being stored and/or transported, for example in a shed or on the bed of a truck trailer, respectively.

In one exemplary embodiment of the bag 10, the bag wall may be made of at least two layers of polyethylene (PE) or of polyamide/polyethylene (PAPE). The total thickness of the bag 10 may be comprised between 180 and 200 microns, and this allows it to package any type of wet or dry seed grain derived from and/or intended for agriculture without the risk of tearing or of surface deformation, with bag contents that may reach masses of the order of several metric tons. Furthermore, a storage bag thus designed provides impermeability to gases for a period of at least one year.

Preferably, the bag 10 is thick enough to prevent rodents from being able to hole it. The nature of the material from which it is made, and its thickness, also allow the bag 10 to protect its contents from any type of radiation which may be harmful to the preservation of the seed grain. Thus, for example, the bag 10 may be opaque and afford a certain degree of protection against ultraviolet radiation and the effects of the sun. In some embodiments, it is possible to add additives to the matrix of the thermoplastic polymer from which the bag is made in order to optimize and improve its properties, such as, for example, its fluidtightness and its protection against ultraviolet radiation or biodegradability properties. Of course, this list of properties is not exhaustive.

Finally, according to one preferred embodiment, the volume of the bag once filled may be in the region of 1 m³. Its size and shape, notably as far as the bottom is concerned, allow it easily to be set down flat on a conventional pallet, for example a pallet measuring 1 m×1 m. This example is not in any way limiting; other dimensions such as, for example, 0.8 m×0.8 m or 1 m×1.2 m may be preferred according to the specifics of the intended application. The height of the bag may be equal to 1 m, 1.2 m, 1.5 m or 2 m, for example, or even a little more. Preferably, the ratio between the height of the bag and its base (i.e., the longest side of the bottom of the bag) does not exceed 3. Thus, the bag full of grain maintains good homogeneity and satisfactory stability in all circumstances, and notably during operations of loading onto/unloading from a transport vehicle, or handling in a storage space such as an agricultural shed.

The filling mouth 11 of the bag, according to one embodiment, may take the form of a narrowing of the diameter of the container at its upper part, as shown in FIG. 1. However, this filling mouth 11 is preferably large enough to allow an acceptable throughput for the filling of the container 10.

In order to hermetically seal the bag, the contours of the filling mouth 11 of the container may be heat sealed together. Other methods of gastight sealing may also be conceived of, in combination or separately, such as closure using grippers or parallel grooves for example.

The storage container 10 may be placed on a pallet 30 made of natural or reconstituted wood, or of plastic or even of composite.

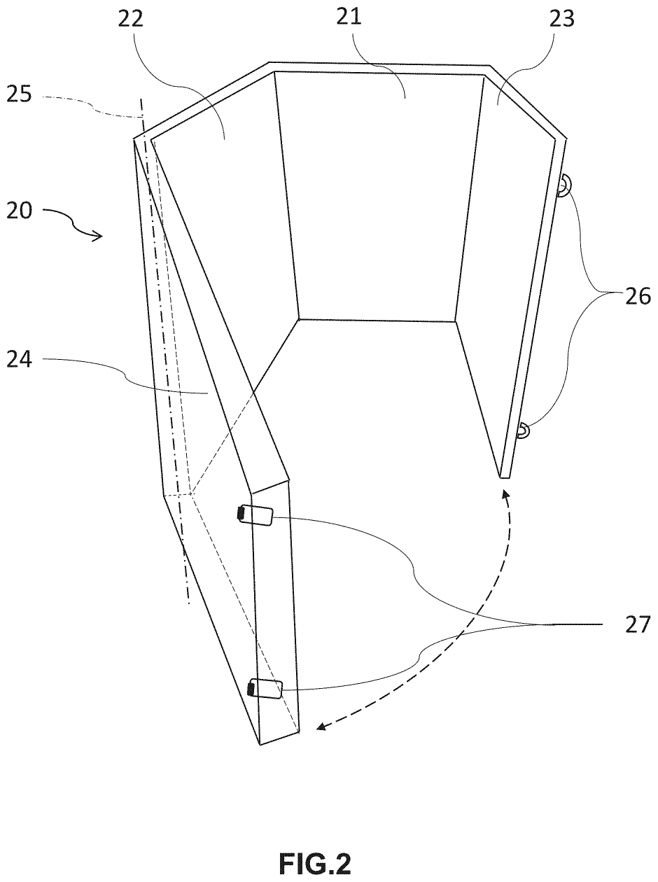

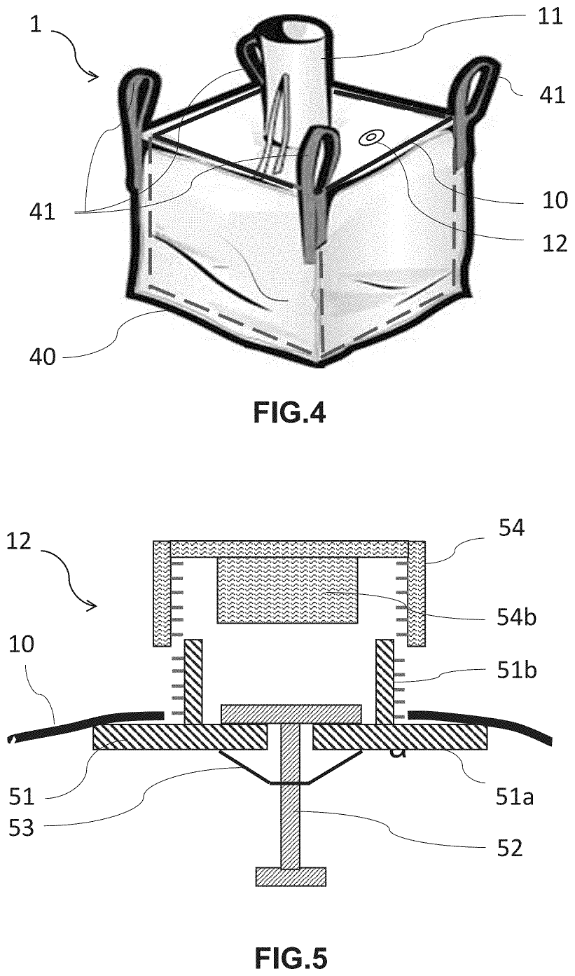

It will now be seen, with reference to FIG. 2, that one property of vacuum preservation may advantageously be exploited in the use of a storage and transport device such as the device 1 of FIG. 4.

Specifically, when the air is sucked out, the raw material inside the hermetic container 10 compacts and becomes a solid block, which is kept compact and rigid because of an intrinsic force of cohesion of the seed grains. According to one alternative form of use of the device, it is possible to use a “mold” of cubic or cylindrical shape for example, in order to give the end result a more advantageous shape.

FIG. 2 shows a schematic depiction of a mold 20 of cubic shape. This mold may be produced in the form of a quadtych, with four mutually independent flat panels: a back panel 21, two side panels 22 and 23, and a front panel 24. The mutual independence of the panels mentioned here means the ability to dismantle them so that the panels can be disconnected from one another, and/or the ability to articulate two adjacent panels to one another so that elements of the quadtych can be folded against one another.

In the example depicted, the front panel 24 is open in relation to the side panel 23. Complementary fixing elements 26 and 27 located on the panel 23 and on the panel 24 respectively, allow these two panels to be assembled. Elements of the same kind may be provided on each of the panels, so that the quadtych can be completely dismantled, with the four panels separated from one another. As an alternative, at least two adjacent panels, such as the panels 22 and 24 in the example depicted in FIG. 2, may be joined together by being articulated to one another by means of a hinge, so that they can be folded towards one another about the axis of rotation 25 in the example.

These arrangements allow the mold to be dismantled and reassembled quickly and easily. One and the same mold can therefore be used for the filling of several bags in succession. In practice, just one mold such as the mold 20 depicted may be enough for use in a conventional agricultural concern. The mold 20 is also made easier to store by this mutual independence of the panels, which is specific to the quadtychs.

As will have been appreciated, the mold is used as follows. Prior to filling, the bag 10 is placed in the mold for example on the pallet 30 of FIG. 1. The mold 20 is then fitted around the pallet. It will be noted that the footprint of the mold corresponds more or less to the dimensions of the pallet 30. All the panels 21, 22, 23 and 24 of the mold 20 are fixed together. Then the bag 10 is filled with grain. The bag and its contents adopt the shape of the mold. The height of the panels 21, 22, 23 and 24 of the mold 20 is at least equal to or even slightly greater than the height of the bag. Once the filling of the bag is complete, the filling mouth 11 is closed, for example heat sealed. The air remaining in the bag is then sucked out via the valve 12. After all the air has been sucked out from inside the bag to outside, the bag maintains the shape of the mold even when the mold is removed by disconnecting and separating the fixing elements 26 and 27.

The panels 21, 22, 23 and 24 of the mold 20 can be made of steel, aluminum, in a honeycomb structure, like house door panels or the like. Advantageously, the mold according to the embodiments described hereinabove is manually portable, for example can be positioned by one or more operators without the use of lifting gear.

As an alternative, the panels 21, 22 and 23 are made of concrete and may be implanted permanently in the ground, with just the front panel 24 being openable, as a door, so that the device 1 of FIG. 1, namely the bag 10 and its associated pallet 30, can be introduced and removed.

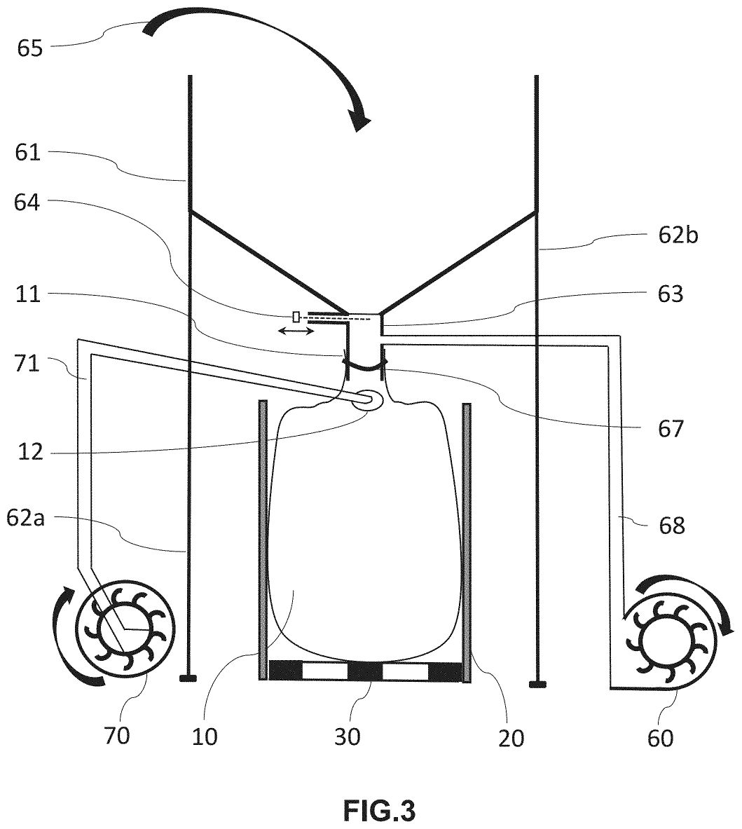

FIG. 3 illustrates a concrete example of the use of the device 1 of the invention. In this example, the bag 10 is placed in a cubic mold 20 as described hereinabove with reference to FIG. 2, and on a conventional pallet 30. Above this assembly is a grain tank 61, which rests on the ground via posts such as the posts 62a and 62b.

Grain is tipped into the hopper of the grain tank 61, as indicated by the arrow 65, for example using a pipe supported by a bracket, or by an endless screw or conveyor belt mechanism (which elements are not depicted).

The filling mouth is fitted around the outlet pipe 63 of the grain tank 61. In one embodiment, the pouch formed by the bag 10 is inflated before it is filled with grain, in order to shape it, more or less, in the mold 20. For that purpose, the installation may comprise a blower 60 associated with piping 68 which communicates with the outlet pipe 63 of the grain tank 61 downstream of its guillotine slide valve 64. In order to avoid air leaks at this point, it is possible to place a tourniquet 67 around the mouth 11 to clamp it against the outlet tube 63 of the grain tank 61, below the guillotine slide valve 64.

With the guillotine slide valve 64 of the grain tank 61 closed, the blower 60 is switched on so that air is blown into the bag 10. This has the effect of inflating same. The bag 10 then presses itself more or less against the internal walls of the mold 20. Once this result has been achieved, the blower 60 can be stopped.

When the guillotine slide valve 64 of the grain tank 61 is opened, the grain flows under the effect of gravity into the bag 10 via the filling mouth 11. The aforementioned tourniquet 67 around the filling mouth 11 against the outlet tube 63 of the grain tank 61 then makes it possible to prevent grains from escaping at this point.

Once the bag 10 is full, the guillotine slide valve 64 is closed again, halting the fall of grain. The bag 10 is then sealed at its filling mouth 11, which for this purpose is detached from the grain tank 61. Once the bag 10 is sealed, the air inside is sucked out using, for example, a suction system connected to the air nonreturn valve 12 of the bag 10. Finally, the front door 24 (cf, FIG. 3) of the mold 20 can be opened and the mold opened up. The pallet 30 on which the bag 10 and its contents is resting can be removed from the mold enclosure.

As far as the way of sucking out the internal fluid is concerned, a suction device 70, external to the system, can be used. The user may for example elect to suck out the air inside by placing the end of the suction pipe 71 of an industrial-type extractor into the valve 12. Purely for information, it is enough to provide a certain minimum power of, for example, 250 W and a minimum depression of, for example, 20 kPa to obtain inside the bag enough of a vacuum for the inerting of the agricultural produce to be effective.

With reference to FIG. 4, one embodiment of a device for the vacuum storage and transportation of grain according to the invention consists in placing the hermetic bag 10 directly inside a transport bag or “bigbag” 40 (this is the generic English-language term used for a giant bag), and then filling the hermetic bag 10 and placing it under vacuum in situ.

The bigbag 40 is associated with the container 10 and comprises handling means, in the form of its four ears 41 which allow the bag 10 to be lifted. Depending on the size of the bigbag, and therefore on its laden weight, this handling can be performed either manually by one or more operators or using handling equipment or a handling gear. Stated differently, the device 1 is provided with elements that make manual or mechanical handling easier, namely the straps that form the ears of the bigbag 40 in the example depicted in FIG. 4.

Whereas the device of FIG. 1 (bag 10 associated with a pallet 30) is particularly well suited to “bigbags” of 1000 kilos or more, for example for storing and transporting wet seed grain for cattle feed, for example, the embodiment described hereinabove with reference to FIG. 4 is also suited to bags of smaller sizes, for example weighing a few kilograms under vacuum, i.e., 5 kg, 10 kg, 15 kg or 20 kg for example. Specifically, in the specific field of seeds, the unit quantities in which dry seed grain is stored and transported are often of this order of magnitude, namely between 5 and 20 kg.

The hermetic bag is placed empty into the bigbag, and only its filling mouth protrudes to the outside via the filling mouth of the bigbag. Prior to filling, it is possible to inflate all of this by blowing air in so that the hermetic bag hugs the walls of the bigbag. After filling, the mouth of the hermetic bag is heat sealed. Once vacuum packaging is complete, the filling mouth of the bigbag can also be closed.

A person skilled in the art will appreciate that, in this embodiment, the bigbag 40 also acts as a mold because it gives the filled bag the substantially cubic or cylindrical shape defined by its envelope. Let us recall at this point that bigbags are made of woven plastic materials and are not at all elastic.

One embodiment of the air nonreturn valve 12 will now be described with reference to FIG. 5.

It will be recalled that the valve 12 prevents any transfer of gaseous fluid from the outside toward the inside of the container. According to one preferred embodiment of the invention, the valve comprises three elements: a fixing 51, a shut-off member 52 and a cap 54.

The fixing 51 is for example made of rigid plastic and cylindrical in shape. It can be integrated (for example bonded) into/onto the surface of the bag 10, by a flat portion 51a of the fixing 51. This portion 51a has at its center an orifice in which the shut-off member 52 can slide. At the fixing 51, the storage bag has a circular opening, the diameter of which coincides with that of the pipe 51b (or nozzle) of the valve 51. Ideally, this pipe 51b is the only path via which fluids can be exchanged between the inside and the outside of the bag 10 after the bag has been sealed. The exterior wall of the said fixing 51 comprises screw threads that allow the cap 54 to be screwed on.

The shut-off member 52 is the element that allows the gaseous fluid to pass from the inside toward the outside but not in the opposite direction. To this end, it is coupled to the flat portion 51a of the fixing by an elastic element 53, such as a spring leaf, for example. In one embodiment, the shut-off member 52 is made of soft and elastic plastic, of the rubbery type. The shut-off member 52 takes the form of a stem with two disks, one at each of the ends of the stem. The stem is inserted through the central orifice of the flat portion 51a of the fixing. The large-diameter disk remains on the outside while the small-diameter disk remains on the inner side of the wall of the bag 10. The two disks act as end stops limiting the amplitude of translational movement of the stem through the orifice in order to prevent it from leaving the orifice.

When suction is applied to the external side of the valve 12, the shut-off member 52 is also sucked against the action of the spring 53, and slides in a translational movement in the orifice of the flat portion 51a of the fixing 51. The inner disk, however, prevents the shut-off member from completely leaving the orifice. The outer disk is in a raised position and allows air to pass from inside to outside the bag 10. Conversely, when the container 10 is under vacuum, the shut-off member 52 is attracted toward the inside and the outside disk presses firmly against the fixing 51a and thus prevents air from entering the bag. In FIG. 5, the shut-off member 52 is thus depicted in the closed position.

The cap 54 may also be made of rigid plastic. On the interior wall of the cylinder of the cap 54, a female screw thread allows the cap to be screwed onto a male screw thread provided on the exterior wall of the nozzle 51b of the fixing 51. Once the cap 54 has been screwed onto the fixing 51, an elastic pad, for example made of polyurethane foam, presses firmly against the shut-off member 52 to ensure better hermetic closure of the valve 12.

The air nonreturn valve need not be reduced to the embodiment described hereinabove. A person skilled in the art will appreciate that other types of nonreturn valve can be used, notably the valves described in documents U.S. Pat. Nos. 5,480,030 and 5,931,189 or alternatively in documents U.S. Pat. Nos. 6,116,781 and 6,357,915.

Embodiments of the present invention have been described and illustrated in the present detailed description and in the figures. The present invention is not restricted to the embodiments given. Other alternative forms and embodiments may be deduced and implemented by those skilled in the art from reading the present description and studying the attached figures.

For example, embodiments of the storage and transport device may provide for the fitting of sensors to detect or measure certain information relating to the content of the bags. Specifically, once a bag is under vacuum it is not possible easily to access it contents, and any opening breaks the vacuum chain to the detriment of the preservation of the seed grain. Sensors arranged in the bag and which can be interrogated remotely, for example using the NRFC (“near range field communication”) protocol or arranged on the wall of the bag and which can be read from outside the bag, allow these disadvantages to be alleviated. By way of nonlimiting example, it is notably possible to envision sensors which sense: moisture, temperature, carbon dioxide level, etc.

In other embodiments still, it is also possible to provide RFID (“radiofrequency identification”) labels for rapid identification of each storage unit. For example, the container comprises at least one RFID label (or “tag”) to identify the device from among a plurality of similar devices. The container or the associated transport means may also comprise geotags so that they can be tracked in real time while they are being transported and/or traced in the event of theft, etc.

In the claims, the term “comprise” does not exclude other elements or other steps. The various features presented and/or claimed may advantageously be combined. Their presence in the description or in various dependent claims does not exclude this possibility. The reference signs in the drawings should not be interpreted as limiting the scope of the invention.

In general, in the following claims, the terms used should not be construed to limit the claims to the specific embodiments disclosed in the specification and the claims, but should be construed to include all possible embodiments along with the full scope of equivalents to which such claims are entitled.

1. A device for the vacuum storage and vacuum transportation of wet or dry seed grain under anaerobic conditions, comprising:
a container hermetically sealed against any type of gas, having:
at least one filling element which, when the element is in the open position, allows the container to be filled with seed grain and also, when said element is in the closed position, allows the container to be hermetically sealed, and
at least one air nonreturn valve allowing gaseous fluidic transfer by sucking air through the valve only from the inside of the container toward the outside of the container, and
a handling arrangement associated with the container and comprising a transport bag suited to accommodating the hermetic container and which has straps forming ears to allow it to be grasped directly by a user or by lifting gear.

2. The device as claimed in claim 1, in which the container is a flexible and hermetic bag made of a thermoplastic material suited to the preservation of agricultural products.

3. The device as claimed in claim 1, in which the filling element is a mouth which is inscribed in the continuity of an envelope of the container.

4. The device as claimed in claim 1, in which the filling element is adapted to be heat sealed.

5. The device as claimed in claim 1, in which the air nonreturn valve is integrated directly into a surface of the container.

6. The device as claimed in claim 1, in which the container comprises sensors suited to detecting or measuring information relating to the seed grain stored in the sealed hermetic container.

7. The device as claimed in claim 1, in which the container further comprises at least one RFID label to identify the device from among a plurality of similar devices.

8. The device as claimed in claim 1, in which the container or the associated transport arrangement further comprise a geotag.

9. A method for preserving wet or dry seed grain under anaerobic conditions and transporting it without breaking the vacuum chain, wherein the gaseous environment of the material to be preserved is rendered fluidically closed in the hermetic container of a device as claimed in claim 1, and has a lower gaseous dioxygen content than the ambient air, for example of the order of 20% of the gaseous dioxygen content of the ambient air at the time that the hermetic container is sealed.

10. A container for the vacuum storage and vacuum transportation of wet or dry seed grain, having all the features of the gastight hermetic container of the device as claimed in claim 1.
